(19) United States
(12) Patent Application Publication
(10) Pub. No.: US 2007/0086094 A1
(43) Pub. Date: Apr. 19, 2007

(54) Prism assembly and method for forming air gap thereof

(75) Inventors: Hsing-Ta Tang, Taoyuan Hsien (TW); Fang-Chuan Ho, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/544,667

(22) Filed: Oct. 10, 2006

(30) Foreign Application Priority Data
Oct. 13, 2005 (TW) 94135705

(51) Int. Cl. G02B 5/04

(52) U.S. Cl. 359/831; 359/896

(57) ABSTRACT

The invention provides a prism assembly and method for forming an air gap thereof. At least one recess is formed on one surface of a conjunction portion of two prisms. The recess is located at a region having a predetermined distance with respect to an edge of the prisms. An adhesive with spacer disposed between the recess and the edge of the prisms is used to adhere the prisms each other to form the air gap therebetween.

### BACKGROUND OF THE INVENTION

1. Field of the Invention

The invention relates to a prism assembly and method for forming an air gap thereof, and in particular relates to an optical element assembly capable of refracting light beams or chromatographically splitting light beams.

2. Description of the Related Art

With the rapid development of projectors in different fields, such as large projection systems in the large forum and projection monitors or TVs in a commercial setting, projectors are popularly used for display.

In FIG. 1, a conventional projection system 10 includes an illumination device 12, a light source 14, a reflective elliptic mask 16, a color wheel 18, a light tunnel 20, a relay lens assembly 30, a refractive device 40, a digital micro-mirror device (DMD) 50, a projection lens 60 and a screen 70. A light beam generated from the light source 14 is reflected by the reflective mask 16 and passed through the color wheel 18. Then the light beam is guided and output by the light tunnel 20. After entering the light tunnel 20 and exiting therefrom, the light beam maintains a uniform light beam. The uniform light beam passed the relay lens assembly 30 and is reflected to DMD 50, and further, the uniform light beam is projected to the projection lens 60 from the refractive device 40. Finally, a reflected image is projected on the screen 70 by the projection lens 60.

The refractive device 40 includes two total internal reflection prisms (TIR prisms) 41′ and 42′. A mirroring surface 410′ formed on the prism 41′. Before the light beam is projected to the screen 70, the light beam is, transmitted via the sequence of the DMD 50, the prism 41′ and the prism 42′. Thus, a gas gap must be formed between the prisms 41′ and 42′ for total internal reflection on the mirroring surface 410′ of the prism 41′ and to prevent the initial light beam entering the prisms 41′ from directly entering the prism 42′.

In general, the gas gap between the prisms 41′ and 42′ can be formed by placement of an adhesive mixed with objects having a predetermined height; or an adhesive adhering a coated film or layer therebetween. U.S. Pat. No. 4,138,192 discloses that a transparent adhesive is placed between two prisms and a refractive index difference between the prisms and the transparent adhesive causing total reflection is applied to a scope.

In FIGS. 2A and 2B, an adhesive 80, such as epoxy, is applied to the edges of the surface 420′ of the prism 42′, for example, of the refractive device 40. When the surface 410′ of the prism 41′ is attached to the surface 420′ of the prism 42′, the prisms 41′ and 42′ can be adhered each other by the adhesive 80. Thus, a gas gap 401′ can be formed therebetween by the adhesive 80.

In FIG. 2C, a multi-layer film 45 is coated on both side edges of the surface 420′ of the prism 42′ by physical vapor deposition (PVD) and the adhesive 80 is applied to the surface of the film 45. When the surface 410′ of the prism 41′ is attached to the surface 420′ of the prism 42′, the prisms 41′ and 42′ can be adhered each other by the adhesive 80 on the film 45. Thus, the gas gap can be formed between the prisms 41′ and 42′ by the film 45 and the adhesive 80.

The adhesive 80 is a glue or soft material. However, the thickness of the adhesive 80 between the assembled prisms 41′ and 42′ cannot be easily controlled, i.e., the gas gap between the assembled prisms 41′ and 42′ cannot be precisely formed. Further, excess adhesive 80 outflows from the surfaces 410′ and 420′ of the prisms 41′ and 42′ when a exterior force is applied to the prisms 41′ and 42′, and the light path 46 of the prisms 42′ shown in FIGS. 2A and 2C may be polluted by the excess adhesive 80 to reduce the amount of the light beam entering the refractive device 40 and to decrease the quality of imaging of the projection system 10.

### BRIEF SUMMARY OF INVENTION

A detailed description is given in the following embodiments with reference to the accompanying drawings.

The feature of the invention is to provide a prism assembly and method for forming an air gap thereof to precisely control the thickness of the gas gap of the prism assembly in order to uniformize the adhesive between the prisms, to improve the rate of use of the light beams, to keep excess adhesive from the surface of the prisms away from a light path, and to increase availability of the projection system.

The invention provides a prism assembly and method for forming an air gap thereof. At least one recess is formed on at least one surface of a conjunction portion of two prisms. The recess is located at a region having a predetermined distance with respect to an edge of the surface. An adhesive applied between the recess and the edge of the surface is used to adhere the prisms each other to form the air gap therebetween.

### BRIEF DESCRIPTION OF DRAWINGS

The invention can be more fully understood by reading the subsequent detailed description and examples with references made to the accompanying drawings, wherein:

FIG. 1 is a schematic view of a conventional projection system;

FIG. 2A is a schematic view of a conventional prism;

FIG. 2B is a schematic view of a conventional prism assembly;

FIG. 2C is a schematic view of an another conventional prism;

FIG. 3A is a schematic view of a prism assembly (M) of the invention;

FIG. 3B is a sectional view-of the prism-assembly (M) of line (A-A′) of FIG. 3A; and

FIG. 3C is an enlarged view of a region (z) of FIG. 3B.

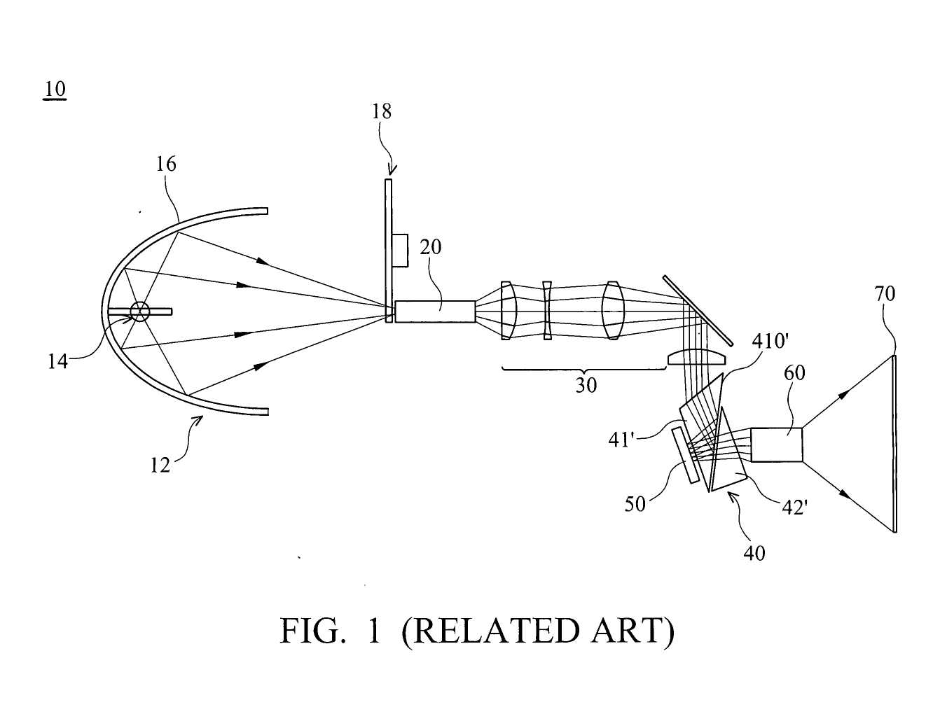

### DETAILED DESCRIPTION OF INVENTION

The following description is of the best contemplated mode of carrying out the invention. This description is made for the purpose of illustrating the general principles of the invention and should not be taken in a limiting sense. The scope of the invention is best determined by reference to the appended claims.

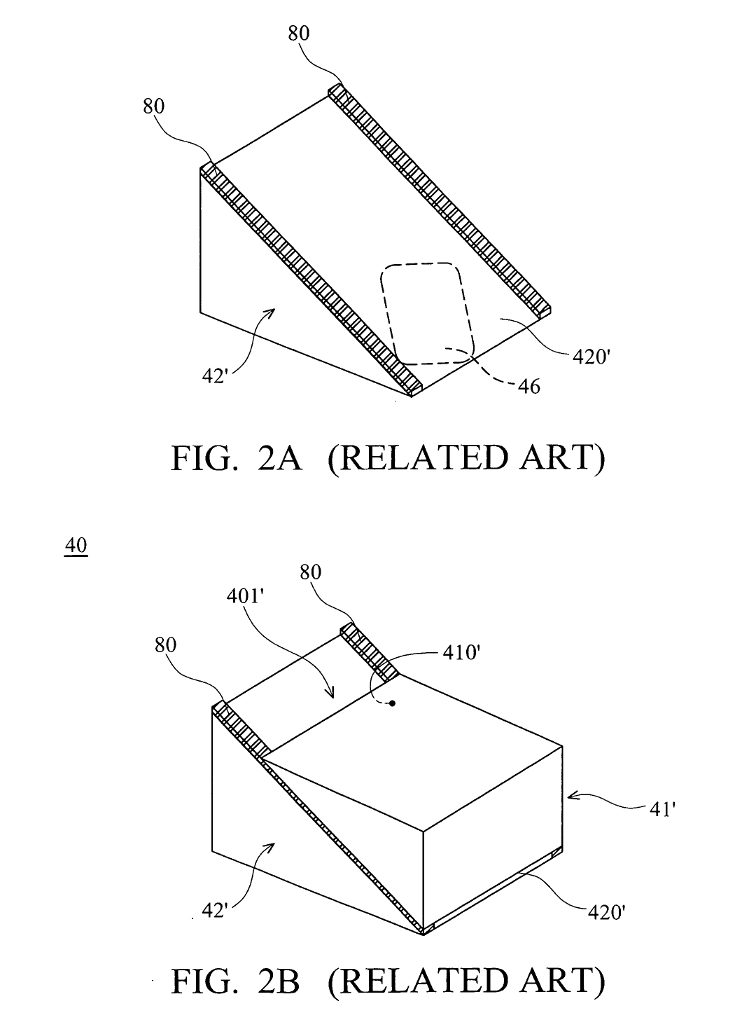

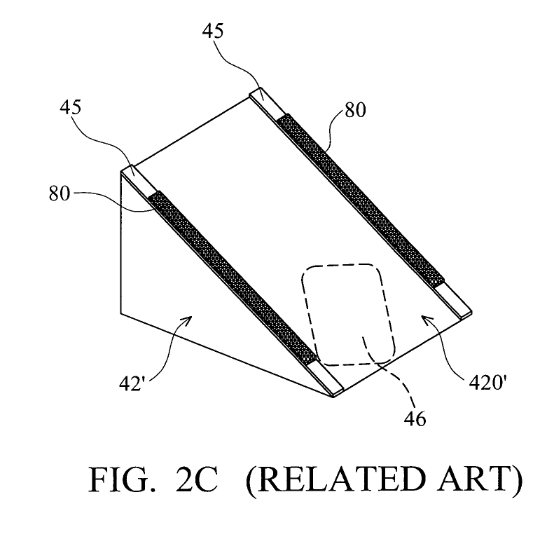

The assembly of the projection system and the principle of imaging are disclosed in the described related art. The invention provides a prism assembly M to improve the rate of use of the light beams of the refractive device 40 composed of the prisms 41′ and 42′ in FIG. 2B.

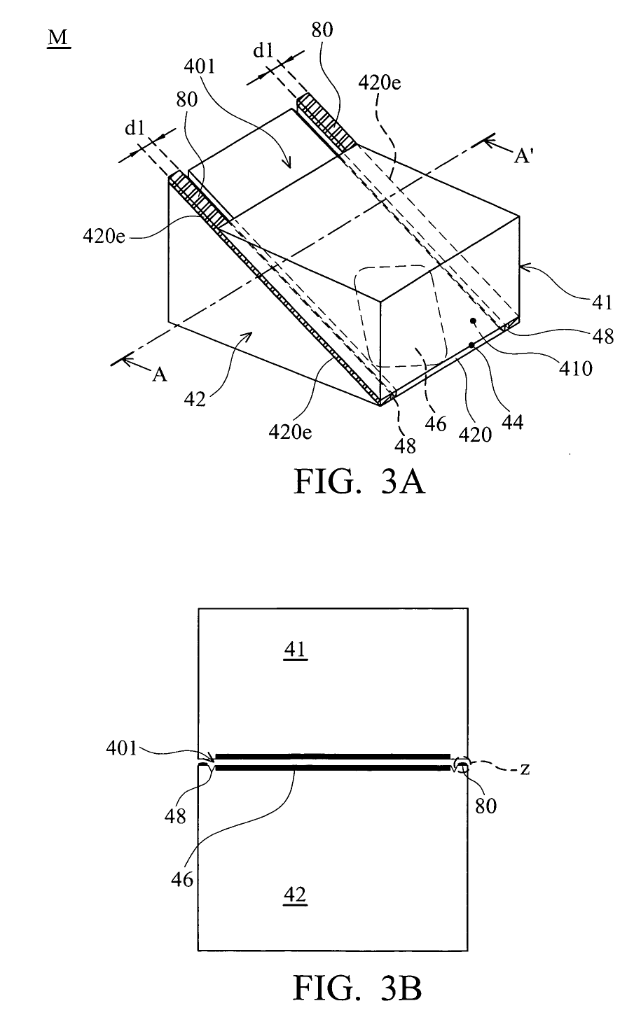

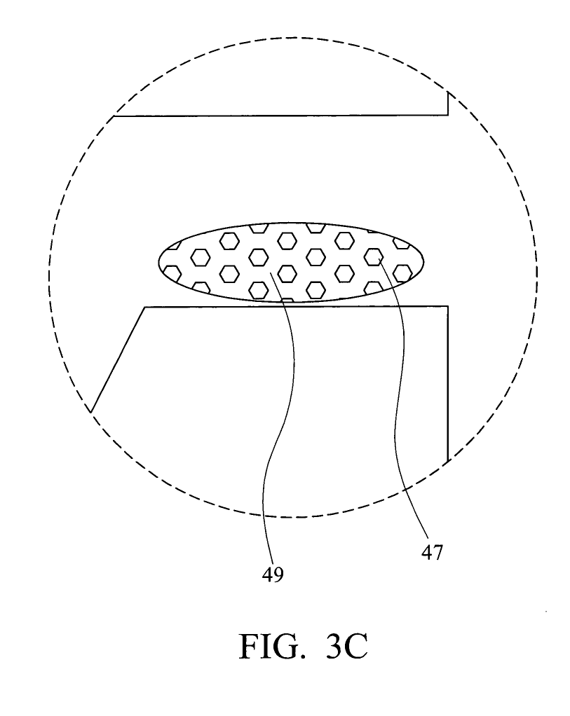

As shown in FIG. 3A, a prism assembly M includes a first prism 41 having a first surface 410, a second prism 42 having a second surface 420 and at least one recess 48 formed on the second surface 420, and an adhesive 80 applied between the recess 48 and the edge 420e. The first surface 410 of the first prism 41 and the second surface 420 of the second prism 42 form a conjunction portion 44, i.e., the first surface 410 of the first prism 41 and the second surface 420 of the second prism 42 have the same edge 420e with the conjunction portion 44. The recess 48 located at a region has a predetermined distance d1 with respect to an edge 420e of the conjunction portion 44, and the recess 48 is a striped slot parallel to the edge 420e of the conjunction portion 44.

In this embodiment, the second prism 42 provides two recesses 48 oppositely located at the predetermined distance d1 with respect to the edges 420e of the conjunction portion 44, the length of the recesses 48 can be equal to or smaller than that of the edges 420e of the conjunction portion 44, and the recess 48 can be formed by a cutting device such as diamond grinder or tool machine, or etching by chemical material. In other embodiments, the recess can be formed on the first surface 410 of the first prism 41.

Note that the recess 48 must be located between the edge 420e and a light path 46, and the recess 48 is kept at a desired distance from the conjunction portion 44 and the light path 46, respectively. Thus, the adhesive 80 is applied on the region between the recess 48 and the edge 420e of the conjunction portion 44, to keep the recess 48 away from the light path 46.

In FIGS. 3B and 3C, the adhesive 80 is a mixture of a plurality of spacers 47 and a bonding material 49. In this embodiment, the bonding material 49 is UV glue, and the spacers 47 can be a plurality of glass balls coated with metallic film, metallic balls or spherical bodies, or constituted by fibers. In particular, the metallic film can be replaced by dielectric film. In other embodiments, the spacer can be a single or multi-layer film with predetermined thickness formed between the recess 48 and the edge 402e of the conjunction portion 44 by PVD.

When the first and second prisms 41 and 42 are bonded by the adhesive 80, the adhesive 80 can be solidified by a curing step. In other embodiments, the bonding material 49 can be UV glue. Note that the thickness of the spacers 47 is the same as the distance of the gas gap 401 between the first and second prisms 41 and 42.

The adhesive 80 formed by the bonding material 49 and the spacers 47 is applied on the first or second prism 41 or 42 so that the excess adhesive 80 outflowed from the surface of the first or second prism 41 or 42 can be removed by a centrifugal force formed by a rotating disk (not shown). The adhesive 80 coated on the first and second prism 41 or 42 is uniformed and the spacers 47 can be averagely deployed on the first and second prisms 41 or 42 to prevent the excess adhesive 80 from flowing out when the first and second prisms 41 and 42 are pressed and to prevent pollution of the light path 46.

Thus, the invention provides a uniform gas gap 401 between the first and second prisms 41 and 42, to overcome the problems of the related arts shown in FIG. 2C.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for forming an air gap of a prism assembly, comprising the steps of:
providing at least two prisms;
forming at least one recess on one surface of a conjunction portion of the prisms, wherein the recess is located at a region having a predetermined distance with respect to an edge of the prisms;
applying an adhesive on the surface between the recess and the edge; and
adhering the prisms by the adhesive to form the air gap therebetween.

2. The method as claimed in claim 1, wherein the step of forming at least one recess comprises forming two parallel recesses.

3. The method as claimed in claim 1, wherein the recess is parallel to the edge.

4. The method as claimed in claim 3, wherein the length of the recess is equal to or smaller than that of the edge.

5. The method as claimed in claim 1, wherein the recess is formed by diamond grinder or tool machine, or etched by chemical material.

6. The method as claimed in claim 1, wherein the adhesive comprises a mixer of a spacer and a bonding material.

7. The method as claimed in claim 6, wherein the bonding material comprises UV glue.

8. The method as claimed in claim 6, wherein the spacer comprises a predetermined height.

9. The method as claimed in claim 6, wherein the spacer comprises glass, fiber or a plurality of balls constituted by glass or metal.

10. The method claimed in claim 9, wherein the balls comprises a metallic or dielectric film coated thereon.

11. The method as claimed in claim 1, wherein the step of forming at least one recess further comprises forming a spacer with a predetermined thickness between the surface of the recess and the edge by physical vapor deposition.

12. The method as claimed in claim 1 further comprising a processing step to apply the adhesive on the prisms so that the excess adhesive outflows from the surface of the prisms by a centrifugal force generated by the rotating disk.

13. The method for forming the air gap of the prism assembly as claimed in claim 1 further comprising a curing step to cure the adhesive.

14. A prism assembly, comprising;
at least two prisms;
a conjunction portion between the two prisms;
at least one recess formed on the conjunction portion, wherein the recess is located at a region having a predetermined distance with respect to an edge of the conjunction portion; and
an adhesive disposed between the recess and the edge.

15. The prism assembly as claimed in claim 14, wherein the recess is a striped slot parallel to the edge.

16. The prism assembly as claimed in claim 14, wherein the length of the recess is equal to or smaller than that of the edge.

17. The prism assembly as claimed in claim 14, wherein the recess is formed by diamond grinder or tool machine, or etched by chemical material.

18. The prism assembly as claimed in claim 14, wherein the adhesive comprises a mixer of a spacer and a bonding material.

19. The prism assembly as claimed in claim 18, wherein the bonding material comprises UV glue.

20. The prism assembly as claimed in claim 18, wherein the spacer comprises a predetermined height.

21. The prism assembly as claimed in claim 18, wherein the spacer comprises glass, fiber or a plurality of balls constituted by glass or metal.

22. The prism assembly as claimed in claim 18, wherein the spacer comprises a metallic film or a dielectric film.
